(19) United States
(12) Patent Application Publication
(10) Pub. No.: US 2013/0344615 A1
(43) Pub. Date: Dec. 26, 2013

(54) FLUID SAMPLING APPARATUS AND COLLECTOR PAD SPLITTER

(71) Applicant: Moishe Bodner, Brooklyn, NY (US)

(72) Inventors: Moishe Bodner, Brooklyn, NY (US); Robert Bernstine, Chesapeake City, MD (US); Vince Rizzo, Indianapolis, IN (US)

(21) Appl. No.: 13/921,667

(22) Filed: Jun. 19, 2013

Related U.S. Application Data
(60) Provisional application No. 61/661,759, filed on Jun. 19, 2012.

(51) Int. Cl. G01N 1/18

(52) U.S. Cl. CPC G01N 1/18
USPC 436/174; 422/566; 422/547

(57) ABSTRACT

A fluid sampling apparatus having a container and a splitter disposed in the container. The splitter is operative for dividing an absorbent pad of a sample collector into two portions. The splitter may have a base and clamping arrangement connected to the base. The clamping arrangement is operative for clamping onto a first portion of the absorbent pad so that the first portion of the absorbent pad can be separated from a second portion of the absorbent pad by pulling the sample collector away from the splitter.

### RELATED APPLICATIONS

This application claims the benefit of U.S. Provisional Application No. 61/661,759 filed Jun. 19, 2012, the entire disclosure of which is incorporated herein by reference.

### FIELD

The disclosure relates to a fluid sampling apparatus. More particularly, the disclosure relates to a fluid sampling apparatus for collecting, storing, and dividing or splitting a sample of a fluid and a device for dividing or splitting a sample pad of a fluid sample collector and a method for a dividing or splitting a fluid sample.

### BACKGROUND

Body fluids have long been used to diagnostically test and monitor for various biochemical and/or physiological conditions of a person's body. Typically, blood and urine samples are used to analyze and determine various conditions of the body.

More recently, oral fluids or saliva have been used to analyze and provide valuable information regarding various bodily conditions. For example, saliva may be used for diagnostically testing an individual for a variety of medical conditions or drug use including, without limitation, hepatitis, HIV, nicotine and cocaine. Clinics for oncology, neurology, infertility, allergy orthopedic and pain typically use samples of saliva for such testing.

The use of saliva as a diagnostic test medium can be more desirable than blood because saliva is readily obtained without the use of intrusive sampling methods, such as needles and syringes. Saliva testing can also be more desirable than urine testing because saliva sampling can be easily monitored to ensure that the sample has been obtained from the person of interest.

Devices designed for sampling saliva and other fluids may use an absorbent collection member to absorb a fluid specimen. Since the diagnostic test may need to be repeated to adequately identify or verify a condition, at least a second fluid sample may be required. Currently, this may require a technician to obtain a second fluid sample from the person using a second sampling device, which increases the cost, time, and inconvenience of sampling.

Accordingly, a fluid sampling device or apparatus that reduce or eliminates the need for obtaining multiple fluid samples from a person is needed.

### SUMMARY

Disclosed herein is a device for dividing an absorbent pad of a sample collector into two portions. The device may comprise a clamping arrangement for clamping onto a first portion of the absorbent pad so that the first portion of the absorbent pad can be separated from a second portion of the absorbent pad by pulling the sample collector away from the device.

In some embodiments the device may further comprise a base member for supporting the clamping arrangement.

In some embodiments of the device the base member may have an annular shape.

In some embodiments of the device the clamping arrangement may include a clamping member.

In some embodiments of the device the clamping member may be C-shaped.

In some embodiments the device may further comprise a resilient arm member connecting the clamping member to the base member.

In some embodiments of the device the clamping member may include a beveled leading edge surface.

In some embodiments of the device the base member may define an opening with opposing ear portions.

In some embodiments of the device the clamping arrangement may further include another clamping member and wherein the ear portions may align with a gap between the clamping members.

In some embodiments of the device the ear members may each have a chamfered edge.

Also disclosed is a fluid sampling apparatus. The fluid sampling apparatus may comprise a container; and a splitter disposed in the container, the splitter for dividing an absorbent pad of a sample collector into two portions. In some embodiments the splitter may comprise a clamping arrangement for clamping onto a first portion of the absorbent pad so that the first portion of the absorbent pad can be separated from a second portion of the absorbent pad by pulling the sample collector away from the splitter. In other embodiments, the splitter may comprise a base and a clamping arrangement connected to the base.

In some embodiments of the apparatus the splitter may be actuated by engaging the clamping arrangement with a sidewall of the container.

In some embodiments of the apparatus the sidewall of the container may have a stepped inner surface.

In some embodiments of the apparatus the sidewall of the container may have a tapered inner surface.

In some embodiments of the apparatus the base member of the splitter may have an annular shape.

In some embodiments of the apparatus the clamping arrangement of the splitter may include a clamping member.

In some embodiments of the apparatus the clamping member of the splitter may be C-shaped.

In some embodiments of the apparatus the splitter may further comprise a resilient arm member connecting the clamping member to the base member.

In some embodiments of the apparatus the base member of the splitter may define an opening with opposing ear portions.

In some embodiments of the apparatus the clamping arrangement of the splitter may further include another clamping member and wherein the ear portions align with a gap between the clamping members.

In some embodiments of the apparatus the ear members of the splitter base may each have a chamfered edge.

In some embodiments of the apparatus the sidewall of the container may have a stepped inner surface defining first and second container sections, the first and second container sections having different diameters, wherein the splitter may be actuated by engaging the clamping arrangement with the one of the first and second container sections having the smaller one of the different diameters.

In some embodiments of the apparatus the sidewall of the container may have a tapered inner surface and a diameter which progressively decreases along the tapered inner surface, wherein the splitter may be actuated by engaging the clamping arrangement with a portion of the inner surface that has a diameter which smaller than another portion of the inner surface.

Also disclosed is a method for splitting a fluid sample. The method may comprise providing a sample collector with an absorbent pad; collecting a fluid sample with the absorbent pad of the sample collector; and splitting the absorbent pad into two portions.

In some embodiments, the splitting comprises fixing the position of one of the two portions of the absorbent pad and pulling the sample collector away from the fixed portion of the absorbent pad.

In some embodiments, the fixing is performed within a container.

In some embodiments, the fixing includes clamping the one of the two portions of the absorbent pad within the container.

In some embodiments, the fixing is performed with a clamp.

### BRIEF DESCRIPTION OF THE DRAWINGS

FIG. 1 is a perspective view of an embodiment of a fluid sampling apparatus.

FIG. 2 is a sectional elevational view of an illustrative embodiment of a container of the fluid sampling apparatus.

FIG. 3 is a perspective view of an illustrative embodiment of a closure of the fluid sampling apparatus.

FIGS. 4A and 4B are elevational and partial perspective views, respectively, of an illustrative embodiment of a fluid collector of the fluid sampling apparatus.

FIGS. 5A-5C are top perspective, elevational, and top plan views, respectively, of an illustrative embodiment of a collector pad splitter of the fluid sampling apparatus.

FIGS. 6A and 6B are sectional elevational views showing an illustrative embodiment of a fluid sampling method using the fluid sampling apparatus.

FIG. 6C is a sectional top perspective view showing the illustrative embodiment of the fluid sampling method using the fluid sampling apparatus.

FIG. 7 is an elevational view of the fluid collector after splitting of the pad.

### DETAILED DESCRIPTION

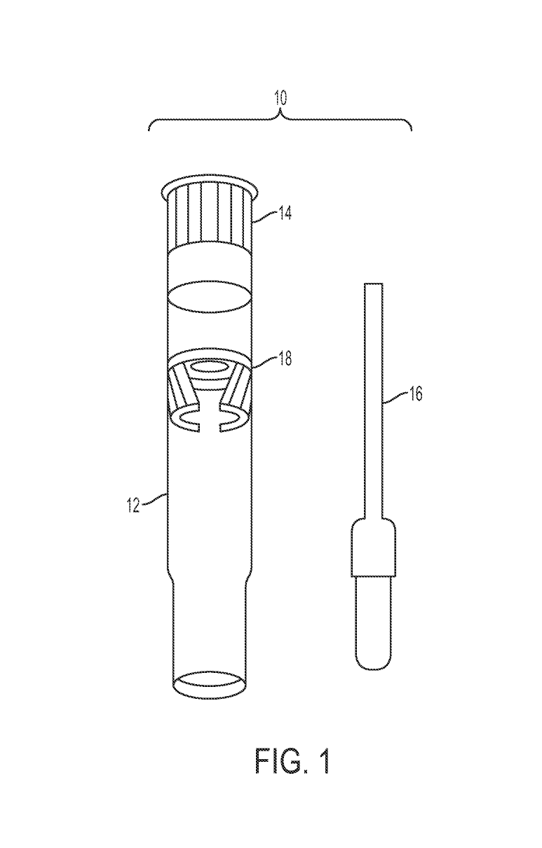

FIG. 1 shows an embodiment of a fluid sampling apparatus 10 for collecting, storing, and splitting a sample of fluid, such as saliva, other body fluid, or fluid other than a body fluid, according to an aspect of the disclosure. The fluid sampling apparatus 10 may comprise a container 12, a closure 14, a fluid collector 16, and a collector pad splitter 18.

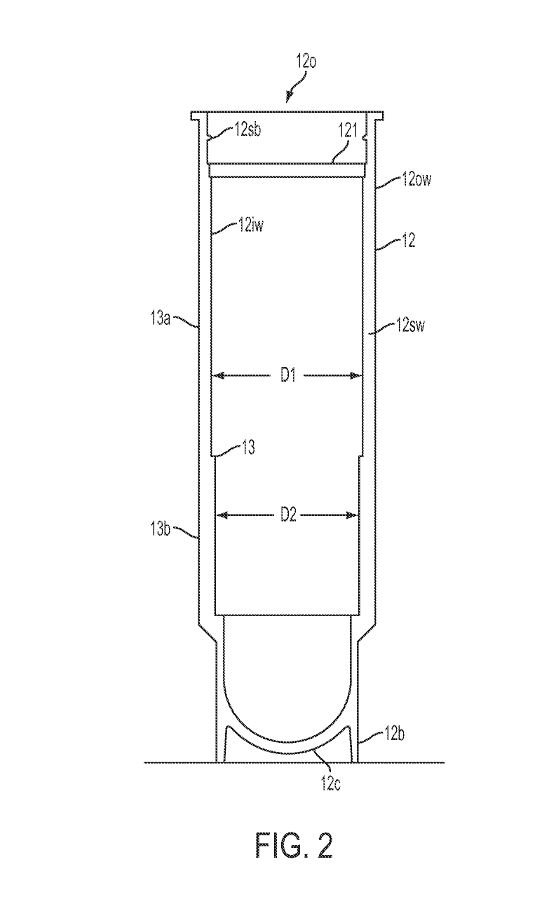

Referring to FIG. 2, some embodiments of the container 12 may have a tube-like configuration comprising a side wall 12sw having a closed end 12c with a rim-like base 12b and an open end 12o disposed opposite to the closed end 12c. The base 12b allows the container 12 to stand up-right on a support surface. The side wall 12sw may have a continuous outer surface 12ow and a stepped inner surface 12iw. The stepped inner surface 12iw includes a step 13 that divides the interior of the container 12 into a first container section 13a having a first inner diameter D1 and a second container section 13b having a second inner diameter D2, which may be less than the first inner diameter D1. A sealing bead 12sb may be provided on the inner side wall 12iw near the open end 12o. A splitter locking groove or bead 121 may also be provided on the inner side wall 12iw, which cooperates with the splitter 18 (e.g., receives or engages the base 18b of the splitter 18) to initially locate the splitter 18 in the upper portion of the container 12 (near the open end 12o), thereby preventing the splitter 18 from moving down the container 12 prior to the use thereof. In some embodiments, the container 12 may contain a solution, such as a buffer solution, to maintain and/or stabilize the pH of the fluid sample.

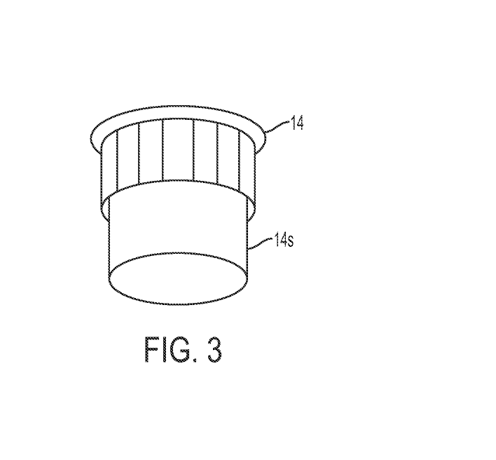

Referring to FIG. 3, some embodiments of the closure 14 may include a body 14b and a stopper member 14s axially extending from the body 14b. The closure 14 may be used for closing the open end 12o of the container 12 (FIG. 1) and may be constructed to mechanically couple to the open end 12o of the container 12 so that the stopper member 14s enters the container 12 and engages the sealing bead 12sb on the inner surface 12iw of the container side wall 12sw thereof in a hermetic manner.

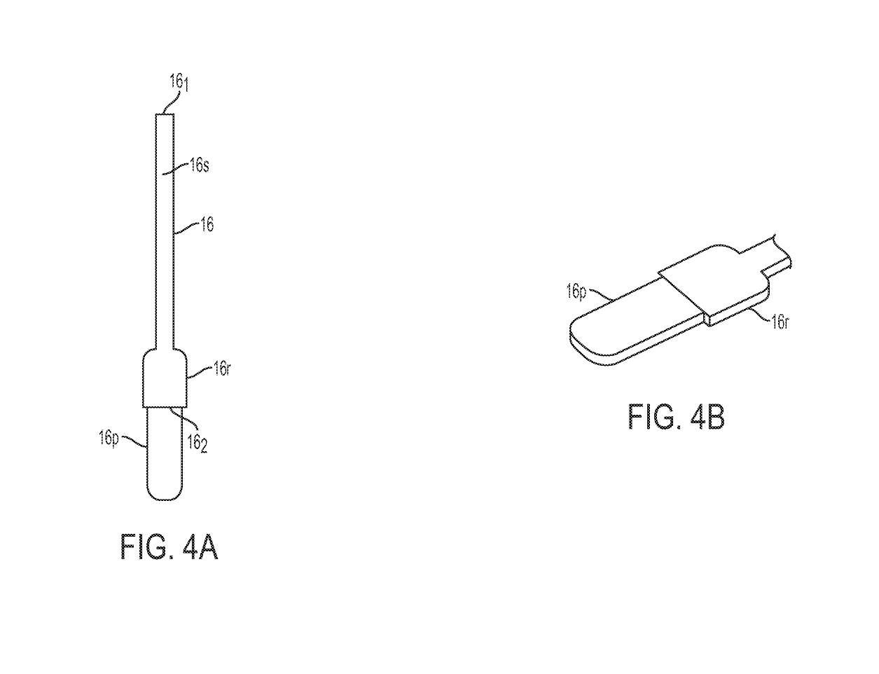

Referring to FIGS. 4A and 4B, some embodiments of the fluid collector 16 may be constructed so that a technician can collect the fluid sample from a person without touching the sample. In such embodiments, the fluid collector 16 may comprise a stem 16s having a first end 16₁ and a second end 16₂ opposite the first end 16₁. The first end 16₁ of the stem 16s may be adapted for allowing a technician to manually grasp the collector 16 with the technician's hand. The second end 16₂ of the stem 16s may define a receptacle 16r for fixedly receiving an end portion of an absorbent pad 16p to attach it to the stem 16s. The absorbent pad 16p may be sized and shaped to be comfortably placed in a mouth of a person or other subject to collect a sample of saliva fluid from the person for diagnostic testing. The absorbent pad 16p may comprise a piece of filter paper or any other suitable material that is capable of absorbing fluid such as saliva or any other desired fluid.

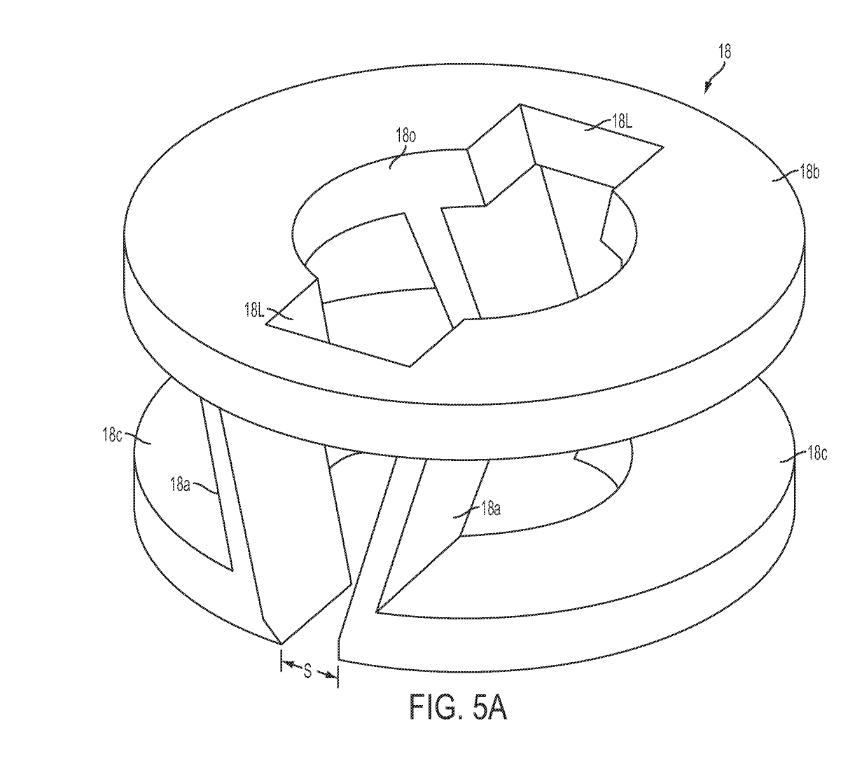

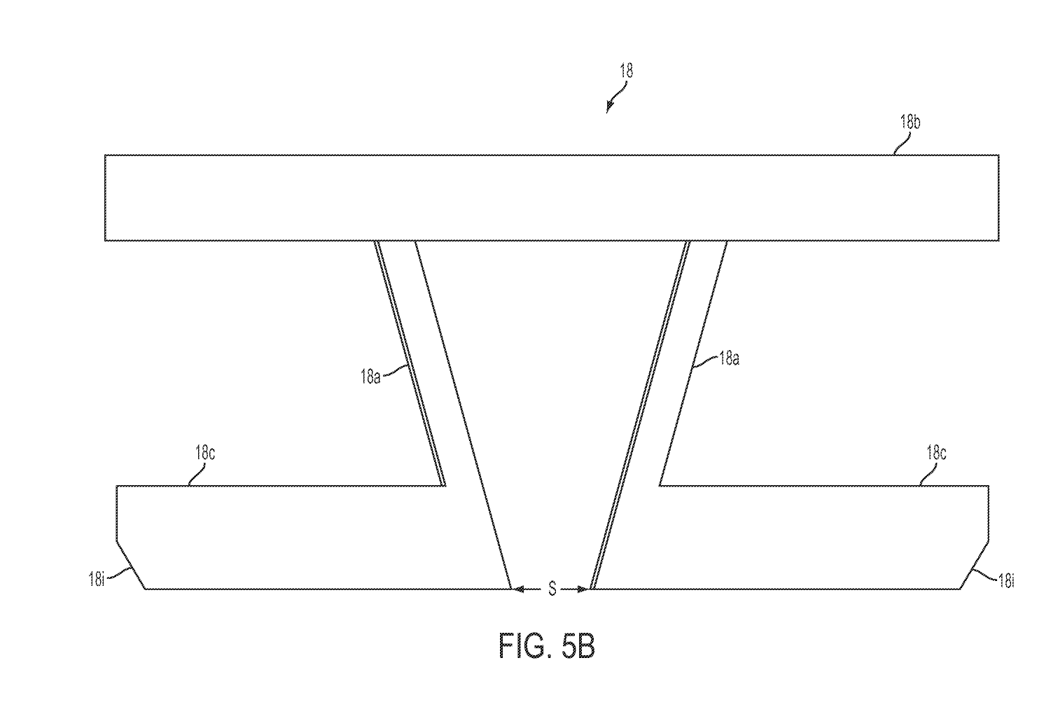

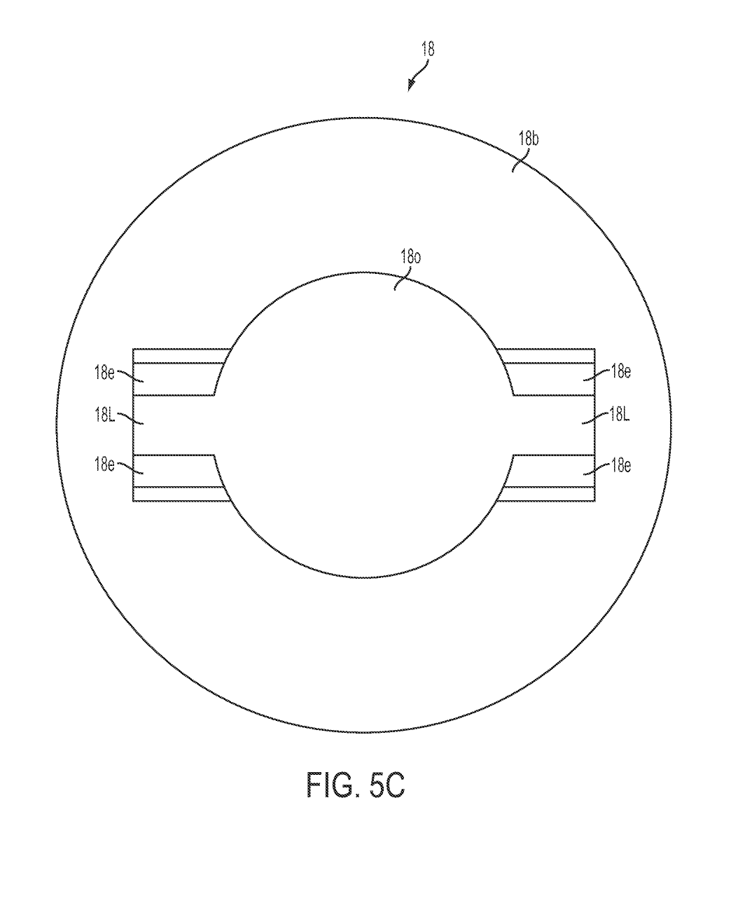

Referring to FIGS. 5A-5C, some embodiments of the collector pad splitter 18 may comprise an annular base or body member 18b defining an opening 18o, a pair of C-shaped clamping members 18c, and a pair of resilient arm members 18a connecting each clamping member 18c to the body member 18b. Each of the clamping members 18c may have an inclined or beveled, leading outer edge surface 18i. The body member 18b of the splitter 18 may be sized so that the body member 18b can enter the groove formed in the inner surface 12iw of the container sidewall 12sw in a snap-fit manner during assembly of the splitter 18 and the container 12, and then be dislodged from the groove by the fluid collector 16 when it is inserted into the container by the technician during the sampling process. The sizing of the body member 18b and the clamping members 18c of the splitter 18 should also allow the splitter 18 to be moved by the fluid collector 16 through the first container section 13a of the container 12 in the direction of the second container section 13b of the container 12 such that the clamping members 18c enter the second container section 13b, but where the body member 18b cannot because it contacts the step 13 on the inner surface 12iw of the container sidewall 12sw.

Referring still to FIGS. 5A-5C, in some embodiments, the opening 18o defined by the base member 18b of the splitter 18 may include opposing ear portions 18_{L} that align with a gap or space S between the clamping members 18c. The ear portions 18_{L} allow the lateral portions of the absorbent pad 16p of the collector 16 to pass through the base member 18b. This structure forces the technician to align the absorbent pad 16p of the collector 16 with the ear portions 18_{L} of the splitter base 18b before the absorbent pad 16p can move through the base 18b of the splitter 18, thereby ensuring that the absorbent pad 16p will enter the space S between the clamping members 18c in the proper orientation so that the absorbent pad 16p can be properly clamped by clamping members 18c. In some embodiments of the collector pad splitter 18, as shown in FIG. 5C, the ear portions 18_{L} of the base member opening 18o may each have a chamfered edge 18e to facilitate passage of the collector absorbent pad 16p through the splitter base member 18b.

Other embodiments of the collector pad splitter 18 may include alternate structures which allow the splitter 18 to clamp and hold the absorbent pad 16p of the collector 16 (containing a fluid sample), so that the technician can split or tear the pad 16p into two or more portions when inserted therein during the fluid sampling process.

The container 12, the stem 16s and receptacle 16r of the collector 16, the closure 14 and the splitter 18 may each be formed from plastic or any other suitable material. In some embodiments, the collector pad splitter 18 may comprise a unitarily formed member. In other embodiments, the collector pad splitter 18 may be formed in separate, discrete parts (one or more of which may be made from plastic or any other suitable material) that are integrated or assembled together.

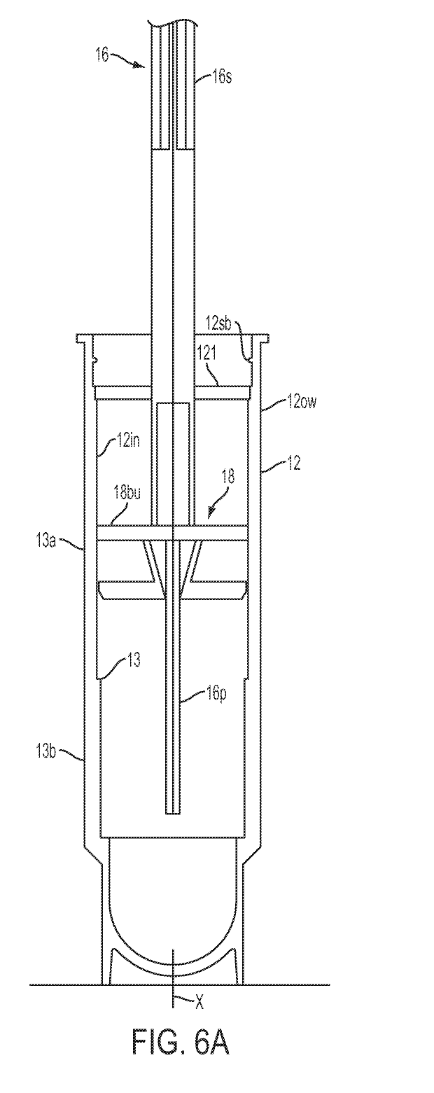

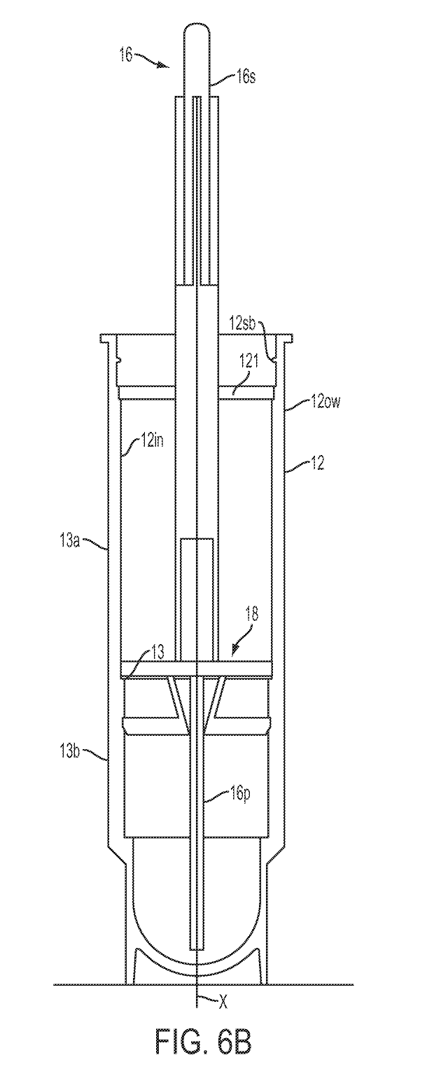

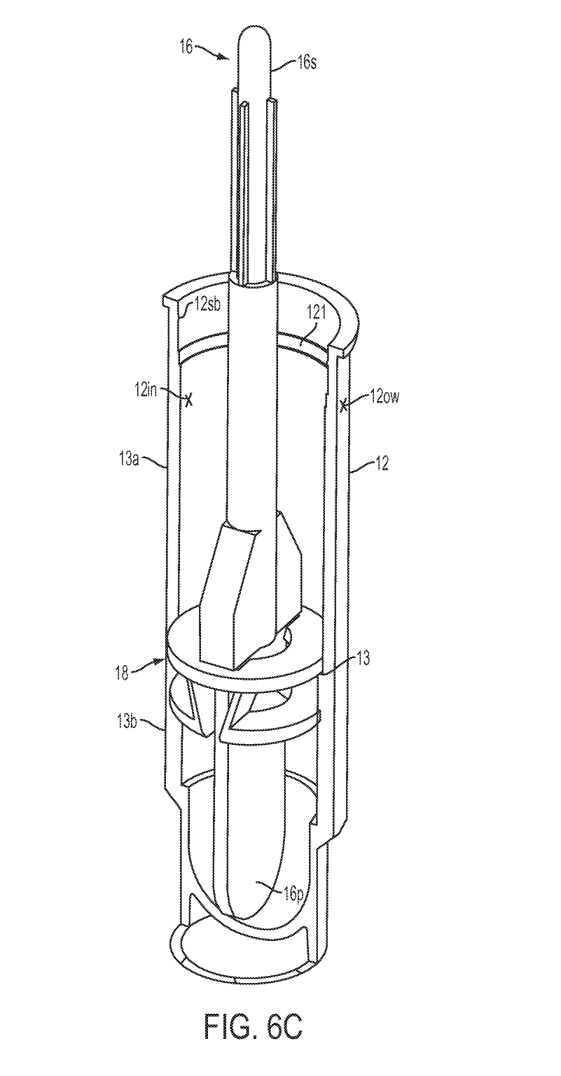

An illustrative embodiment of a fluid sampling method using the fluid sampling apparatus of the disclosure will now be described with reference to FIGS. 6A-6C. In the method, the technician may first remove the closure 14 of the container 12 from the open end 12o of the container 12. The technician may then grasp the stem 16s of the collector 16 and place the absorbent pad 16p of the collector 16 into a person's mouth to collect a saliva fluid sample. Once the pad 16p has absorbed the fluid sample, the technician may grasp the collector 16 by the stem 16s and remove it from the person's mouth and insert the collector 16 into the open end 12o of the container 12, such that the absorbent pad 16p enters and passes through the opening 18c, 18_{L} of the splitter 18 until the receptacle 16r of the collector 16 engages an upper surface 18bu of the splitter base 18b, as shown in FIG. 6A. In FIG. 6A, a portion of the pad 16p is disposed in the space S between the clamping arms 18c when the receptacle 16r of the collector 16 engages the splitter base 18. Also in FIG. 6A, the collector 16 has dislodged the splitter base 18b from the locking groove or bead 121 in/on the inner surface 12iw of the container sidewall 12sw and moved the splitter 18 through the first container section 13a toward the second container section 13b.

As the collector pad slitter 18 is driven further down through the first container section 13a of the container 12, the inclined edge surfaces 18i of the clamping members 18c contact step 13 formed at the junction of the first and second container sections 13a, 13b. The inclined edge surfaces 18i of the clamping members 18c allow the clamping members 18c to slide over the step 13 and enter the second container section 13b. As the clamping members 18c of the splitter 18 enter the second container section 13b, the resilient arms 18a of the splitter 18 bend, thereby allowing the clamping members 18c to move towards one another and firmly clamp the absorbent pad 16p of the collector 16 therebetween.

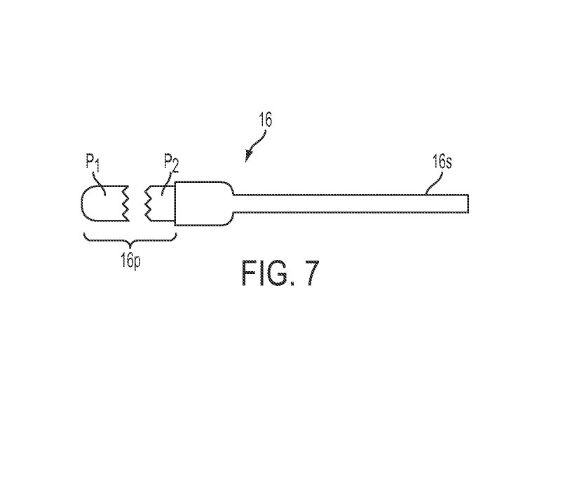

FIGS. 6B and 6C show the base 18b of the collector pad splitter 18 engaged with the step 13 formed in the inner surface 12iw of container sidewall 12sw after the splitter 18 has been pushed down through the first container section 13a by the technician using the collector 16. As can be seen, the clamping members 18c of the splitter 18 are now disposed in the second container section 13b of the container 12 with the smaller inner diameter with the absorbent pad 16p clamped firmly between the clamping members 18c of the splitter 18. In this position, the splitter 18 is effectively locked into place within container 12 so that it can't move back toward the first container section 13a if the technician pulls on the stem 16s of the collector. Therefore, the technician can now split or divide the absorbent pad 16p of the collector 16 by pulling on the stem 16s of the collector 16 to withdraw it from the container 12, thereby tearing the absorbent pad 16p of the collector 16 into two portions as shown in FIG. 7. The torn-off portion P1 of the absorbent pad 16p with the fluid may remain in the container 12 for testing. The portion P2 of the absorbent pad 16p remaining with the collector 16 may be saved for future testing (e.g., for backing up the results of the first test), if necessary.

In some embodiments, the torn-off portion of the absorbent pad 16p may be released by the splitter 18 into the container 12 by tapping on the outer sidewall 12ow of the container 12.

In other embodiments, the inner side wall of the container 12 may be tapered instead of stepped. The taper, in such embodiments, may extend from the open end 12o to the closed end 12c of the container 12 such that the inner diameter of the container 12 becomes progressively smaller moving from the open end 12o of the container 12 to the closed end 12c of the container 12. As the collector pad splitter 18 is pushed down into the container 12 in such embodiments, the clamping members 18c of the splitter 18 will move towards one another as the inner diameter of the container 12 becomes smaller, thereby firmly clamping the absorbent pad 16p of the collector 16 therebetween. With the absorbent pad 16p clamped firmly between the clamping members 18c of the splitter 18, the technician can split or divide the pad 16p of the collector 16 by pulling on the stem 16s of the collector 16 to withdraw it from the container 12, thereby tearing the absorbent pad 16p into two portions.

Another aspect of the disclosure is a method for splitting a fluid sample. The method may comprise collecting a fluid sample with the absorbent pad of a sample collector and splitting the absorbent pad into two portions. The absorbent pad may be split into two portions by fixing the position of one of the two portions of the absorbent pad and pulling the sample collector away from the fixed portion of the absorbent pad. In some embodiments, the splitting process may take place within a container, where at least one of the two portions of the split absorbent pad remains in the container in a stored manner until it is needed for testing. The process for splitting may include fixing one of the two portions of the absorbent pad within the container using a clamp, a holder or some other securing means and pulling the sample collector away from the fixed portion of the absorbent pad. In other embodiments, the splitting process may take place outside the container where at least one of the two portions of the split absorbent pad is stored in an appropriate manner until it is needed for testing. The process for splitting, in such embodiments, may include fixing one of the two portions of the absorbent pad using a clamp, a holder or some other securing means and pulling the sample collector away from the fixed portion of the absorbent pad.

Although the fluid sampling apparatus of the disclosure has been described in terms of illustrative embodiments, it is not limited thereto. Rather, the appended claims should be construed broadly, to comprise other variants and embodiments of the apparatus, which may be made by those skilled in the art without departing from the scope and range of equivalents of the apparatus and its elements.

What is claimed is:

1. A device for dividing an absorbent pad of a sample collector into two portions, the device comprising a clamping arrangement for clamping onto a first portion of the absorbent pad so that the first portion of the absorbent pad can be separated from a second portion of the absorbent pad by pulling the sample collector away from the device.

2. The device according to claim 1, further comprising a base member for supporting the clamping arrangement.

3. The device according to claim 2, wherein the base member has an annular shape.

4. The device according to claim 2, wherein the clamping arrangement includes a clamping member.

5. The device according to claim 4, wherein the clamping member is C-shaped.

6. The device according to claim 4, further comprising a resilient arm member connecting the clamping member to the base member.

7. The device according to claim 4, wherein the clamping member includes a beveled leading edge surface.

8. The device according to claim 4, wherein the base member defines an opening with opposing ear portions.

9. The device according to claim 8, wherein the clamping arrangement further includes another clamping member and wherein the ear portions align with a gap between the clamping members.

10. The device according to claim 8, wherein the ear members each have a chamfered edge.

11. A fluid sampling apparatus comprising:
a container; and
a splitter disposed in the container, the splitter for dividing an absorbent pad of a sample collector into two portions, the splitter comprising a clamping arrangement for clamping onto a first portion of the absorbent pad so that the first portion of the absorbent pad can be separated from a second portion of the absorbent pad by pulling the sample collector away from the splitter.

12. The apparatus according to claim 11, wherein the splitter is actuated by engaging the clamping arrangement with a sidewall of the container.

13. The apparatus according to claim 12, wherein the sidewall of the container has a stepped inner surface.

14. The apparatus according to claim 12, wherein the sidewall of the container has a tapered inner surface.

15. The apparatus according to claim 11, wherein the splitter further comprises a base member for supporting the clamping arrangement.

16. The apparatus according to claim 15, wherein the base member has an annular shape.

17. The apparatus according to claim 15, wherein the clamping arrangement includes a clamping member.

18. The apparatus according to claim 17, wherein the clamping member is C-shaped.

19. The apparatus according to claim 17, wherein the splitter further comprises a resilient arm member connecting the clamping member to the base member.

20. The apparatus according to claim 15, wherein the base member defines an opening with opposing ear portions.

21. The apparatus according to claim 20, wherein the clamping arrangement further includes another clamping member and wherein the ear portions align with a gap between the clamping members.

22. The apparatus according to claim 20, wherein the ear members each have a chamfered edge.

23. A fluid sampling apparatus comprising:
a container; and
a splitter disposed in the container, the splitter for dividing an absorbent pad of a sample collector into two portions, the splitter comprising a base and clamping arrangement connected to the base, the clamping arrangement for clamping onto a first portion of the absorbent pad so that the first portion of the absorbent pad can be separated from a second portion of the absorbent pad by pulling the sample collector away from the splitter.

24. The apparatus according to claim 23, wherein the splitter is actuated by engaging the clamping arrangement with a sidewall of the container.

25. The apparatus according to claim 23, wherein the sidewall of the container has a stepped inner surface defining first and second container sections, the first and second container sections having different diameters, wherein the splitter is actuated by engaging the clamping arrangement with the one of the first and second container sections having the smaller one of the different diameters.

26. The apparatus according to claim 23, wherein the sidewall of the container has a tapered inner surface and a diameter which progressively decreases along the tapered inner surface, wherein the splitter is actuated by engaging the clamping arrangement with a portion of the inner surface that has a diameter which smaller than another portion of the inner surface.

27. The apparatus according to claim 23, wherein the base member has an annular shape.

28. The apparatus according to claim 23, wherein the clamping arrangement includes a pair of clamping members.

29. The apparatus according to claim 28, wherein each of the clamping members is C-shaped.

30. The apparatus according to claim 28, wherein the splitter further comprises a resilient arm member connecting each of the clamping members to the base member.

31. The apparatus according to claim 23, wherein the base member defines an opening with opposing ear portions.

32. The apparatus according to claim 31, wherein the clamping arrangement includes a pair of clamping members and wherein the ear portions align with a gap between the clamping members.

33. The apparatus according to claim 31, wherein the ear members each have a chamfered edge.

34. A method for splitting a fluid sample comprising:
providing a sample collector with an absorbent pad;
collecting a fluid sample with the absorbent pad of the sample collector; and
splitting the absorbent pad into two portions.

35. The method according to claim 34, wherein the splitting comprises fixing the position of one of the two portions of the absorbent pad and pulling the sample collector away from the fixed portion of the absorbent pad.

36. The method according to claim 35, wherein the fixing is performed within a container.

37. The method according to claim 36, wherein the fixing includes clamping the one of the two portions of the absorbent pad within the container.

38. The method according to claim 35, wherein the fixing is performed with a clamp.
